(19) United States
(12) Patent Application Publication
(10) Pub. No.: US 2013/0283691 A1
(43) Pub. Date: Oct. 31, 2013

(54) DEVICE AND METHOD FOR OBTAINING THE MIXTURE OF OXYGEN AND HYDROGEN BY THE ACTION OF UV RADIATION ON MICRO-CRYSTALS OF ICE WATER

(71) Applicant: Drago Cosic, Zagreb (HR)

(72) Inventor: Drago Cosic, Zagreb (HR)

(73) Assignee: Mario Rendulic, Zagreb (HR)

(21) Appl. No.: 13/977,740

(22) PCT Filed: Dec. 29, 2010
(86) PCT No.: PCT/HR10/00039

§ 371 Date: Jul. 1, 2013

(51) Int. Cl. B01J 19/12

(52) U.S. Cl. CPC B01J 19/123
USPC 48/197 FM; 422/162

(57) ABSTRACT

Present invention refers to a device and method for obtaining a mixture of hydrogen Hz and oxygen Oz through the activity of UV radiation on ice microcrystals. The device comprises a source of UV radiation (2); optical fibre (3) via which the UV radiation is directed from the source of the UV radiation (2) towards the chamber (10) containing the ice microcrystals subjected to the activity of the UV rays; internal chamber (6) in which water vapour is introduced via an injector, in which the internal chamber (6) is situated within the chamber (10) from which it is separated by longitudinal barriers (9); a rotating hollow cylinder (5) around whose perimeter fibres (4) are distributed, cooling device (7) that provides ice microcrystals on the fibres (4), where the cooling device (7) is placed within the rotating hollow cylinder (5) and the outflow (8) for the gaseous Oz and Hz towards the feeder. The said device and method are used for obtaining a mixture of hydrogen Hz and oxygen Oz for driving an internal combustion engine, gas turbine or steam generator as an additional fuel.

### TECHNICAL FIELD

Present invention relates to a device and method for obtaining a mixture of hydrogen and oxygen through the activity of UV radiation on ice water microcrystals. The separation of water into constituent components using UV rays is carried out on the solid aggregate state (ice microcrystals) using a source of light rays of wavelength less than 200 nm with concentrated transfer via an optical fibre onto one or more points of an ice crystal of very small thickness and surface area.

### TECHNICAL PROBLEM

Technical problem solved by the invention in question is obtaining a mixture of hydrogen and oxygen using UV radiation on ice microcrystals, whereas the ratio between the quantity of obtained hydrogen and oxygen gases and the amount of energy spent is multiple times less than using electrolysis or other thermal procedures.

The primary objective of the invention is to obtain a mixture of hydrogen and oxygen which is used as a fuel for running an internal combustion engine, gas turbine, steam generator, etc.

The gaseous components of the separated water molecules (O₂ and H₂) are introduced to a stream and said components by combustion drive the turbine which in turn produces electrical energy. Considering that the device of the invention can occupy a very small space (approx. 0.5 m³), it is suitable for use in the auto industry.

The advantages of the invention are the reduced use of conventional fuels such as natural gas, liquefied gas, etc. for gas turbines, and fuel for internal combustion engines.

In line with the above said, the primary goal of the invention is to obtain a mixture of hydrogen and oxygen which can be used as an addition to gaseous, liquid or solid fuels used in steam generators, or as an additional fuel for internal combustion engines. An additional objective of this invention is the reduction of greenhouse gas emissions. The device of the invention can also be used as part of a gas plant for steam generation, in which the excess steam in the process can be lead to the device for separation, thereby increasing the efficacy of the device itself and of the entire plant.

Greenhouse gas emissions result from the incomplete combustion of carbon during the production of electrical energy in thermoelectric plants and due to the incomplete combustion of fuels in internal combustion engines. The device of the invention may be made so as to occupy a small space of approx. 0.5 m³, thereby making it suitable for use in automobiles, where it can serve as an additional fuel source for internal combustion engines.

The said technical problem is resolved in such a way that the prepared fuel mixture consisting of ice microcrystals is exposed to ultraviolet light rays of wavelength less than 200 nm. Ultraviolet radiation (ultraviolet light; abbreviation UV) comprises electromagnetic radiation with wave lengths less than those of visible light, but greater than those of soft X-rays. An optical fibre concentrates the UV rays on the micro particles of the frozen water crystals of small thickness and area (from 0.0001-0.00001 mm²), and the hydrogen and oxygen are separated out of the ice crystal and carried to, for example, a turbine. With combustion of the mixture in the stream a temperature of about 2500° C. is created, and the combustion of the gases turns the turbine that produces electrical energy or any other feeder. A transformer system is used to turn the electricity from the turbine into the desired form or intended form of the consumer.

### STATE OF THE ART

Document WO2007077366 describes an invention for the procedure of obtaining hydrogen through a dissociation reaction from water using solar radiation within a water processing chamber. The procedure contains the following steps:
a) concentrating solar radiation for the purpose of achieving the intensity of radiation suitable for inducing a photochemical dissociation of water vapours;
b) subjecting at least one photo-catalyst to concentrated solar radiation;
c) dissociation of water vapour molecules into hydrogen and oxygen, which is separated into a border layer that is in contact with the surface of at least one photo-catalyst from the preceding step;
d) selective extraction of hydrogen at the site where it arises using at least one hydrogen sensitive extraction membrane.

Unlike the invention from document WO2007077366, the invention in question separates hydrogen from ice microcrystals and uses exclusively UV radiation for the separation of hydrogen. Furthermore, the said invention, unlike the invention from document WO2007077366, does not use a catalyst to obtain a mixture of hydrogen and oxygen.

The theoretical basis of radiolysis and photolysis of ice and the generation of hydrogen and oxygen is explained in the paper by Cassidy et al. “Radiolysis and Photolysis of Icy Satellite Surfaces: Experiments and Theory”, Space Sci. Rev. 153: 299-315, 2010. The cited paper lists that the main products of incidental radiation of icy satellites using solar systems are hydrogen and oxygen.

### DETAILED DESCRIPTION OF THE INVENTION

The invention in question refers to a device and method for obtaining a mixture of hydrogen and oxygen through the activity of UV radiation on ice water microcrystals. The separation of water into its constituent components using UV rays is carried out on the solid aggregate state (ice microcrystals) using a source of light with wavelengths less than 200 nm with concentrated transfer via an optical fibre onto one or more spots of an ice crystal of very small thickness and surface area.

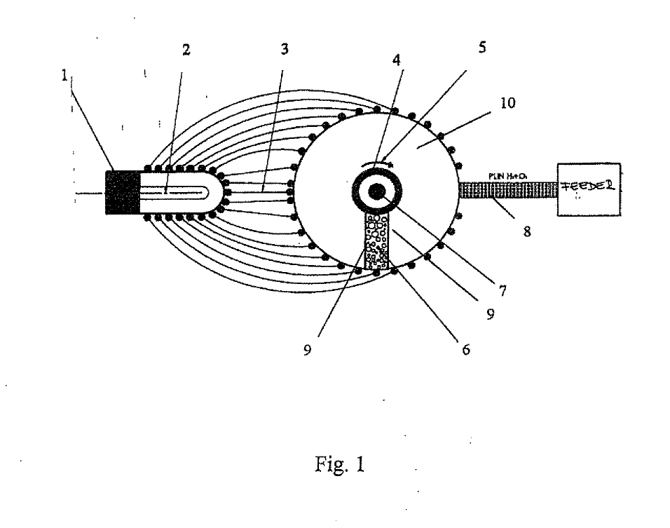

The invention will be described in detail below, with reference to FIG. 1 that gives a schematic overview of the device for obtaining a mixture of hydrogen and oxygen.

The device for obtaining a mixture of hydrogen (H₂) and oxygen (O₂) through the activity of UV radiation on ice water microcrystals consists of a source of UV radiation (2), and optical fibre (3) through which the UV radiation is directed from the source of the UV radiation (2) towards the chamber (10) in which the ice water microcrystals are subjected to the activity of UV rays, and the outlet pipe (8) for the outflow of gaseous O₂ and H₂ towards the feeder. The optical fibre (3) may be an optical cable or any other means for directing UV radiation.

Between the source of radiation (2) and the chamber (10), there may be a filter ensuring the monochromatic radiation of the ice microcrystals. The source of the UV radiation (2) may be a natural source of UV rays, black light, UV fluorescent lamps, UV led diodes, UV laser or gas discharge lamps. Within the chamber (10) is placed a second chamber (6) in which water vapour is introduced via an injector. The internal chamber (6) is separated from the chamber (10) by longitudinal barriers (9). The volume of the internal chamber (6) preferably amounts 10-20% of the volume of the chamber (10). The chamber (10) can be of any shape, i.e. may be of cylindrical, cubic or rectangular shape. The shape of the internal chamber (6) is adapted according to the shape of the chamber (10), while keeping the volume of the internal chamber (6) preferably at 10-20% of the volume of the chamber (10). In the centre of the chamber (10) is placed a rotating hollow cylinder (5). The hollow cylinder (5) rotates at a constant speed ranging from 10 to 50 rpm. Along the perimeter of the cylinder (5) are fibres (4) placed at regular intervals. The distance between neighbouring fibres (4) is preferably from 50 to 500 μm, while the width of the fibres (4) is preferably at intervals of 50 to 500 μm. Within the rotating hollow cylinder (5) is placed a cooling device (7). The cooling device (7) cools the fibres (4) to which water vapour is continually introduced, thereby forming ice microcrystals on the fibres (4). In order to break the bonds in the ice water using photolysis, i.e. to obtain O₂ and H₂ from the radiated ice water, the source of UV radiation (2) emits UV radiation with a wavelength in intervals from 1 to 200 nm.

The feeders may be any machines that for combustion use solid, liquid or gaseous fuel for the generation of steam, i.e. in plants for the production of electrical energy. The device according to the present invention may also be used as part of a gas plant for the generation of steam, in which excess water vapour in the process can be funnelled to the device of the invention, thereby increasing the efficacy of the device itself and the overall plant. Present invention may also be used as an additional source of hydrogen and oxygen that can be applied as an addition to usual fuels in internal combustion engines, thereby achieving significant savings.

Present invention also relates to the method of obtaining a mixture of hydrogen (H₂) and oxygen (02) by the activity of UV radiation on ice water microcrystals. The method according to the invention includes leading water vapour via a chamber (6) into contact with fibres (4) at the perimeter of a rotating hollow cylinder (5), by which cooling ensured by the cooling device (7) ice water microcrystals on the fibres (4) are formed and the said ice microcrystals within the chamber (10) are subjected to UV radiation where microcrystals are separated into H₂ and O₂.

According to this method, the wave length of the UV radiation should be less than 200 nm, and according to the one embodiment of the invention, monochromatic radiation should be ensured within the chamber (10). The wavelength of the UV radiation preferably ranges from 1 to 200 nm. Furthermore, according to this method, the hollow cylinder (5) rotates at a constant speed, preferably at intervals of 10 to 50 rpm.

According to the above, the device and method of this invention are used for obtaining a mixture of hydrogen (H₂) and oxygen (O₂) for driving an internal combustion engine or for use in gas turbines and steam generators as an additional fuel.

1. A device for obtaining the mixture of hydrogen (H₂) and oxygen (O₂) through the activity of UV radiation on ice microcrystals, characterized by that it comprises a source of UV radiation (2); optical fibre (3) via which the UV radiation is directed from the source of the UV radiation (2) towards the chamber (10) containing the ice microcrystals subjected to the activity of the UV rays; internal chamber (6) in which water vapour is introduced via an injector, in which the internal chamber (6) is situated within the chamber (10) from which it is separated by longitudinal barriers (9); a rotating hollow cylinder (5) around whose perimeter fibres (4) are distributed; cooling device (7) that provides formation of ice microcrystals on the fibres (4) where the cooling device (7) is placed within the rotating hollow cylinder (5); and the outlet pipe (8) for leading the gaseous O₂ and H₂ towards the feeder.

2. The device according to the claim 1, characterized by that a filter which ensures the monochromatic radiation of ice microcrystals is placed between the source of radiation (2) and chamber (10).

3. The device according to the claim 1, characterized by that the volume of the internal chamber (6) amounts for 10-20% of the volume of the chamber (10).

4. The device according to the claim 1, characterized by that the width of fibres (4) is in the interval of 50 to 500 microns.

5. The device according to the claim 1, characterized by that the fibres (4) are regularly spaced around the perimeter of the rotating hollow cylinder (5), with a distance between adjacent fibres (4) in the interval of 50 to 500 microns.

6. The device according to the claim 1, characterized by that the source of UV radiation (2) may be a natural source of UV rays, black light, UV fluorescent lamps, UV led diodes, UV lasers and gas discharge lamps.

7. The device according to the claim 1, characterized by that the source of UV radiation (2) emits UV radiation with a wavelength in the interval from 1 to 200 nm.

8. The device according to the claim 1, characterized by that the hollow cylinder (5) rotates at a constant speed selected from the interval of 10 to 50 rpm.

9. The device according to the claim 1, characterized by that the optical fibre (3) is an optic cable.

10. A method for obtaining the mixture of hydrogen H₂ and oxygen 0₂ through the activity of UV radiation on ice microcrystals, characterized by that the water vapour is brought into contact through the internal chamber (6) with the fibres (4) along the perimeter of the rotating hollow cylinder (5), and where due to cooling caused by the cooling device (7) ice microcrystals on the fibres (4) are formed, and where said microcrystals within the chamber (10) are subjected to UV radiation thereby separating the ice microcrystals into H₂ and 0.

11. The method according to claim 10, characterized by that the wave length of the UV radiation is less than 200 nm.

12. The method according to claim 11, characterized by that the wave length of the UV radiation is in the interval of 1 to 200 nm.

13. The method according to claim 10, characterized by that the hollow cylinder (5) rotates at a constant speed selected from the interval of 10 to 50 rpm.

14. The method according to claim 10, characterized by that monochromatic radiation is ensured within the chamber (10).

15. Use of the device according to claims 1 to 10, for obtaining a mixture of hydrogen H₂ and oxygen 0₂ as an additional fuel for driving an internal combustion engine, gas turbine or steam generator.

16. Use of the mixture of the hydrogen and oxygen obtained from the method according to claim 10 as a fuel for driving an internal combustion engine, gas turbine or steam generator
